(19) United States
(12) Patent Application Publication
(10) Pub. No.: US 2023/0104962 A1
(43) Pub. Date: Apr. 6, 2023

(54) SYSTEM AND METHOD FOR VEHICLE SUPPORT

(71) Applicants: Christopher BABULALL, Bradford (CA); Bibi Ryhan MANAN, Bradford (CA)

(72) Inventors: Christopher BABULALL, Bradford (CA); Bibi Ryhan MANAN, Bradford (CA)

(21) Appl. No.: 17/491,920

(22) Filed: Oct. 1, 2021

(51) Int. Cl. G06Q 30/06; G06Q 10/00

(52) U.S. Cl. CPC G06Q 30/0611; G06Q 10/20; G06Q 30/0645; G06Q 50/30

(57) ABSTRACT

A vehicle support marketplace comprising a server receiving information entered by a user on a damaged vehicle. The user making a selection of two or more types of service providers required. A request for service notification is generated by the server to one or more service providers of each of the two or more types of service providers. One or more quote for service, submitted by the one or more service providers. A selection by the user of one quote for each type of service providers required.

### BACKGROUND

When an accident involving a vehicle happens, there is a need to quickly find cost-effective service providers to help mitigate the situation.

### SUMMARY

In one embodiment, a vehicle support marketplace is disclosed, comprising a server receiving information entered by a user on a damaged vehicle; a selection, by the user, of two or more types of service providers required; a request for service notification generated by the server to one or more service providers of each of the two or more types of service providers; one or more quote for service, submitted by the one or more service providers; a selection by the user of one quote for each type of service providers required.

In another embodiment, the vehicle support marketplace of claim 1 wherein the information comprises one or more image or a video of the damaged vehicle.

In another embodiment, the vehicle support marketplace of claim 1 wherein the information comprises a location of the damaged vehicle.

In another embodiment, the vehicle support marketplace of claim 1 wherein the types of service providers comprise a garage, a car body shop, a car rental company or a towing service.

In another embodiment, the vehicle support marketplace of claim 1 wherein the user communicates directly with service providers that have submitted quotes for service.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a high level view of one embodiment.

FIG. 2 illustrates a flow process in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

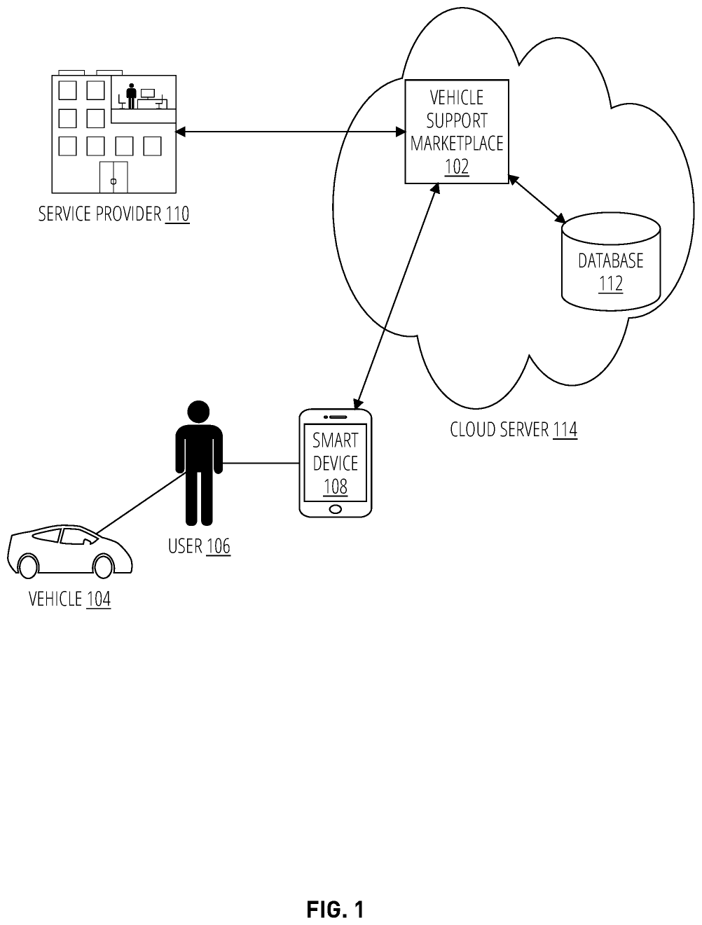

FIG. 1 depicts a user 106 with a damaged vehicle 104. The user 106 signs up to application on a smart device 108 which is coupled to a vehicle support marketplace 102. The vehicle support marketplace 102 is executed on a processor on a server, optionally on a cloud server 114.

One or more service providers 110 have set up an account with the vehicle support marketplace 102. In this embodiment, a service provider 110 can be for example, but not limited to, a garage, a body shop, a rental car company or a towing service.

The vehicle support marketplace 102 stores the data collected on a memory in a database 112.

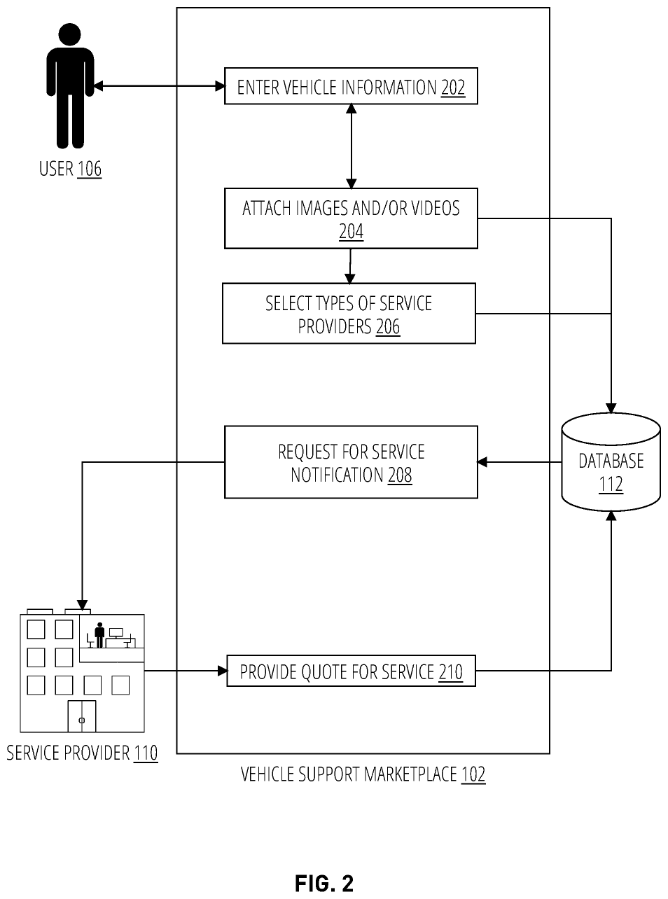

FIG. 2 depicts the flow of information relating to the vehicle support marketplace 102. When the user undergoes damages to a vehicle 104, the user sets up an account with the vehicle support marketplace 102, if not already a member. The user 106 then logs into the vehicle support marketplace 102 to create a new request. The user 106 enter vehicle information 202, such as, for example the VIN number, the make, model, year and or other details of interest. The user 106 also enters its location or uses the GPS of the smart device 108 to provide the location of the vehicle 104. The user 106 attach images and/or videos 204 of the damaged vehicle 104. The user 106 select types of service providers 206 that are required, for example, one or more of a rental car, a body shop job and a towing service. The vehicle support marketplace 102 sends a request for service notification 208 to the relevant service providers 110 signed up in the system. The service providers 110 provide quote for service 210 to the user 106 via the vehicle support marketplace 102. The user 106 can exchange messages with one or more service providers 110 with additional details and the user 106 selects the service providers 110 from the list of quotes received that will be handling the situation and the proper contracts are established to get the service done.

In one embodiment, the quotes are kept secret from each service providers 110. In another embodiment, the vehicle support marketplace 102 offers a change for the service providers 110 to auction a price for the service.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. A vehicle support marketplace comprising:
a server receiving information entered by a user on a damaged vehicle;
a selection, by said user, of two or more types of service providers required;
a request for service notification generated by said server to one or more service providers of each of said two or more types of service providers;
one or more quote for service, submitted by said one or more service providers;
a selection by said user of one quote for each type of service providers required.

2. The vehicle support marketplace of claim 1 wherein said information comprises one or more image or a video of said damaged vehicle.

3. The vehicle support marketplace of claim 1 wherein said information comprises a location of said damaged vehicle.

4. The vehicle support marketplace of claim 1 wherein said types of service providers comprise a garage, a car body shop, a car rental company or a towing service.

5. The vehicle support marketplace of claim 1 wherein said user communicates directly with service providers that have submitted quotes for service.
